(19) United States
(12) Patent Application Publication
(10) Pub. No.: US 2012/0062102 A1
(43) Pub. Date: Mar. 15, 2012

(54) Method of producing light bulbs and fluorescent lighting

(76) Inventor: David Chiang, Oceanside, CA (US)

(21) Appl. No.: 12/807,688

(22) Filed: Sep. 10, 2010

(51) Int. Cl. H01J 1/62; H01K 1/30; H01J 9/24; H01J 5/50

(52) U.S. Cl. 313/483; 313/318.01; 313/110; 445/23

(57) ABSTRACT

A light apparatus includes s light arrangement and a highlighting element. The light arrangement includes a light housing, at least a connector coupling with the light housing for electrically connecting to a power supply source, and at least a light source received in the light housing for generating a non-neon light to penetrate through the light housing. The highlighting element is provided at the light housing and arranged in such a manner that when the light passes through the light housing, the highlighting element creates a neon light emitting effect at the light arrangement.

### BACKGROUND OF THE PRESENT INVENTION

1. Field of Invention

The present invention relates to the light bulbs and fluorescent lighting, and more particularly to the light bulbs and fluorescent lighting, which is able to simulate a conventional neon light emitting effect of neon illuminating apparatus.

2. Description of Related Arts

The conventional light bulbs and fluorescent lightings are widely and commonly applied to various areas, such as installing in a house, office, or any other public places for illuminating the surroundings thereof. The light bulbs or the fluorescent lightings, especially the light bulbs, are one of the oldest arts of illumination apparatus. It has the advantages of being inexpensive, simple in structure, low manufacturing cost, having variety of sizes and voltages, and mutual in art. Therefore, the light bulbs or the fluorescent lightings are able to easily be configured or incorporated with different applications for variety of purposes.

However, the light bulbs and fluorescent lightings have the shortage of having unvaried tone. The color changes or light emitting effects of the light bulbs and fluorescent lightings are monotonous. Furthermore, unlike the conventional neon illuminating apparatus, such as a neon illuminating sign which has high brightness for catching attention of people, the light bulbs and fluorescent lightings are hardly being used as commercial signs or lightings for drawing necessary attentions in public. Thereby, the less attractive illumination signs may be harmful to business.

The neon illuminating apparatus are widely used for commercial sign purposes due to the special and bright neon light emitting effect from the neon illuminating apparatus, so that the neon illuminating apparatus is able to easily catch the attention of the eyes of the people, such as consumers. Therefore, it has been widely applied in variety of areas.

Though the neon illuminating sign has the special neon light emitting effect, the neon illuminating apparatus usually uses argon based tubes as a light source, which may involve complicated producing process and contain relatively more harmful chemicals to damage the environment as well as the user when leakage occurs. In other words, conventional neon illuminating signs contain harmful substance which causes potential danger to the users and the environment. Moreover, the manufacturing process of the conventional neon illuminating signs is complicated, and expensive to operate. The neon illuminating apparatus life is usually shorter and not durable.

As a result, the present invention provides the alternative light bulbs or fluorescent lightings which are able to simulate the conventional neon light emitting effect of the neon illuminating apparatus or sign without substantially alternating the configurations or structures of the light bulbs and the fluorescent lightings.

### SUMMARY OF THE PRESENT INVENTION

The present invention is advantageous in that it provides a light apparatus including light bulbs and fluorescent lighting which is able to simulate the neon light emitting effect of conventional neon illuminating apparatus substantially without alternating the structure thereof.

Another advantage of the present invention is to provide the light apparatus including the light bulbs and fluorescent lighting with simulated neon light emitting effect, which is simple in structure, low manufacturing cost, low operation and maintenance cost, and easily being configured for variety of applications.

Another advantage of the present invention is to provide the light bulbs and fluorescent lighting with simulated neon light emitting effect, wherein the ultraviolet ray phosphor of the highlighting element is coated on the casing of the light bulbs and/or the fluorescent lighting, so that the light generated from the light bulbs and the fluorescent emitted out of the casing is able to generate the neon light emitting effect.

Another advantage of the present invention is to provide the illumination sign utilizing the light apparatus of light bulbs and fluorescent lighting with simulated neon light emitting effect, which is easy to manufacture and simple in structure, wherein the illumination sign could be utilized in a wide variety of circumstances for providing high quality illumination of predetermined sign characters. Moreover, the present invention is capable of utilizing a wide variety of light sources for providing illumination of sign characters.

Additional advantages and features of the invention will become apparent from the description which follows, and may be realized by the following description of the instrumentalities and combinations particular pointing out in the appended claims.

According to the present invention, the foregoing and other objects and advantages are attained by providing a light apparatus, which comprises a light arrangement and a highlighting element.

The light arrangement comprises a light housing, at least a connector coupling with the light housing for electrically connecting to a power supply source, and at least a light source received in the light housing for generating a non-neon light to penetrate through the light housing;

The highlighting element is provided at the light housing and arranged in such a manner that when the light passes through the light housing, the highlighting element creates a neon light emitting effect at the light arrangement.

In accordance with another aspect of the invention, the present invention further provides a method of manufacturing a light apparatus with neon light emitting effect, comprising the following steps.

(A) Receive a light source in a light housing and electrically link the light source to a connector to form a light arrangement for generating a non-neon light to penetrate through the light housing.

(B) Provide a highlighting element at the light housing, wherein when the light passes through the light housing, the highlighting element creates a neon light emitting effect at the light arrangement.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a sectional view of a light apparatus according to a preferred embodiment of the present invention, illustrating the light apparatus being embodied as a light bulb configuration.

FIG. 2 is a sectional view of a light apparatus according to a second preferred embodiment of the present invention, illustrating the light apparatus being embodied as a fluorescent light configuration.

FIG. 3 is a sectional view of a light apparatus according to a third preferred embodiment of the present invention, illustrating the light apparatus being embodied as a LED light configuration.

FIG. 4 illustrates an application of the light apparatus according to the first and third preferred embodiments of the present invention to form an illumination sign.

FIG. 5 illustrates an application of the light apparatus according to the second preferred embodiment of the present invention to form an illumination sign.

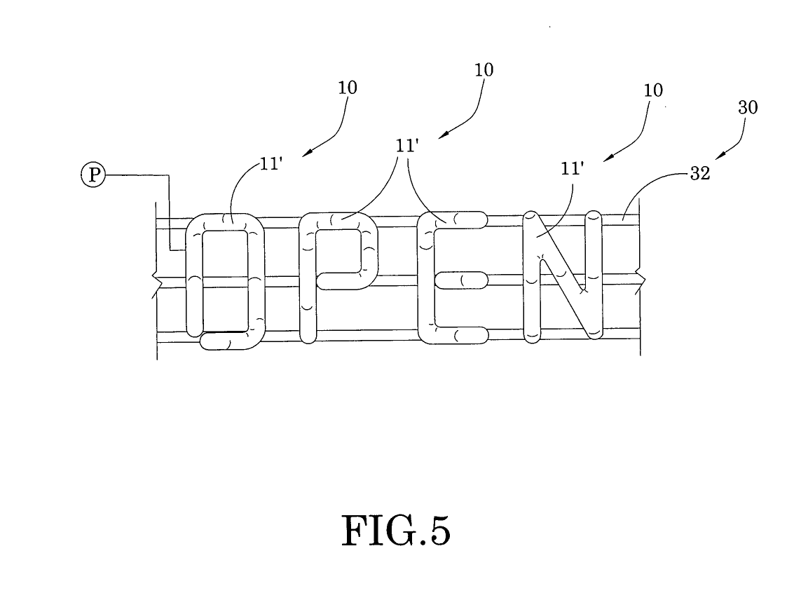

FIG. 6 illustrates an application of the light apparatus according to the above preferred embodiments of the present invention to form an illumination sign.

### DETAILED DESCRIPTION OF THE PREFERRED EMBODIMENT

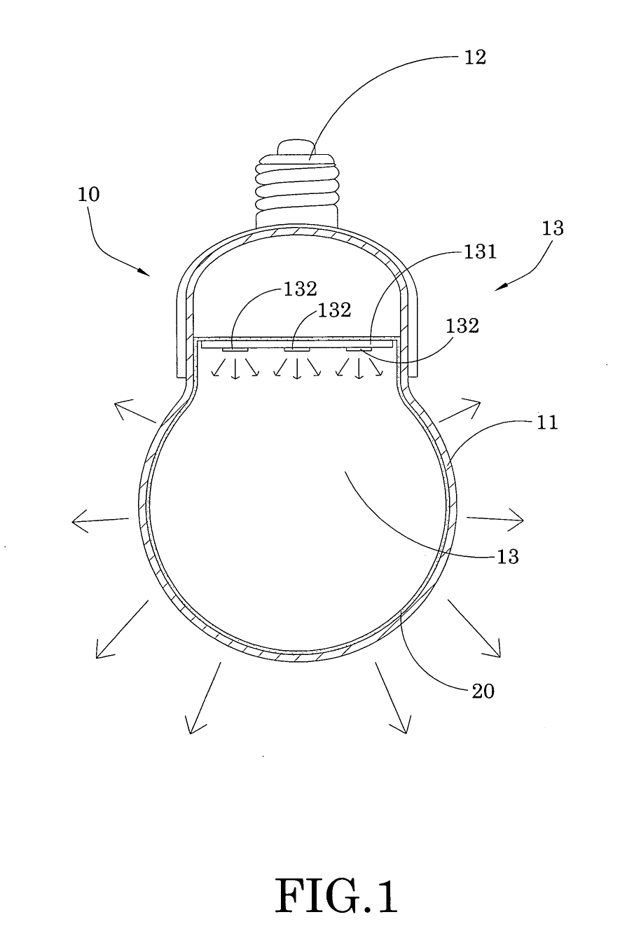

Referring to FIG. 1 of the drawings, a light apparatus according to a first preferred embodiment of the present invention is illustrated, wherein the light apparatus comprises a light arrangement 10 and a highlighting element 20.

The light arrangement 10 comprises a light housing 11, at least a connector 12 coupling with the light housing 11 for electrically connecting to a power supply source, and at least a light source 13 received in the light housing 11 for generating a non-neon light to penetrate through the light housing 11.

According to the first embodiment, the light arrangement 10 is embodied to have a light bulb configuration that the light housing 11 is a light bulb casing and is made of light-transmittable or translucent material. The connector 12 is coupled with the light housing 11 to form a light bulb connector for electrically coupling with a conventional light bulb socket so as to electrically connect to the power supply source.

In addition, the light source 13 comprises at least a diode unit which is electrically connected to the connector 12 and is received in the light housing 11 to form the light arrangement 10 as the light bulb configuration. Therefore, when the diode unit of the light source 13 is electrified, the electrode of the light source 13 will generate the light towards the light housing 11. Accordingly, the diode unit comprises a circuit board 131, such as a semi-conductor chip, and at least a diode 132 electrically coupled at the circuit board 131, such that when the diode 132 is electrified, the diode unit will emit the light. It is worth mentioning that two or more diodes 132 can be electrically coupled at the circuit board 131 to enhance the light intensity of the diode unit.

According to the first embodiment, the highlighting element 20 is provided at the light housing 11 and is arranged in such a manner that when the light passes through the light housing 11, the highlighting element 20 creates a neon light emitting effect at the light arrangement 10. In other words, when the light is transmitted out of the light housing 11 through the highlighting element 20, a simulated neon light of a conventional neon lighting is created. Therefore, through the highlighting element 20, such as coating the highlighting element 20 at the light housing 11 of the light bulb can simple generate the simulated neon light emitting effect without involving the complicated process for producing the conventional neon lightings.

In particular, the highlighting element 20 is ultraviolet ray phosphor coating coated on the light housing 11. Accordingly, the light source 13 generates the light with a wave length matching an ultraviolet wave length of the ultraviolet ray phosphor coating coated on the light housing 11.

Accordingly, the highlighting element 20 can be coated at either the inner or outer surface of the light housing 11. Preferably, the highlighting element 20 is coated on the inner surface of the light housing 11. Therefore, the process of coating the highlighting element 20 without alternating the structure of the light apparatus is able to simply form the light apparatus with the neon light emitting effect. Thus, the light apparatus incorporating with light bulb as the light source 13 is able to emit the simulated neon light emitting effect without using the conventional neon lightings, which is complicated, expensive in manufacturing, operation, and maintenance cost, and short life thereof.

The present invention further provides a method of manufacturing the light apparatus with neon light emitting effect comprising the following steps.

(1) Receive the light source 13 in the light housing 11 and electrically link the light source 13 to the connector 12 to form the light arrangement 10 for generating the non-neon light to penetrate through the light housing 11.

(2) Provide the highlighting element 20 at the light housing 11 to create a neon light emitting effect at the light arrangement 10. Preferably, the highlighting element 20 is coated at an inner surface of the light housing 11.

In order to configure the light arrangement 10 as the light bulb configuration, the step (1) further comprises the following steps.

(1.1) Configure the light housing 11 to form a light bulb housing.

(1.2) Receive the diode unit as the light source 13 within the light housing 11 to electrically link with the connector 12 so as to form the light bulb configuration.

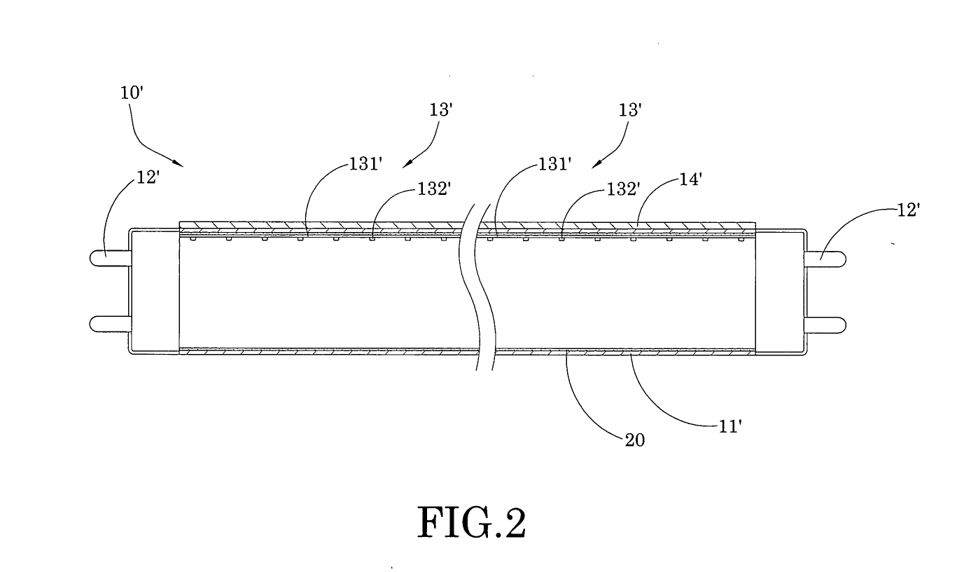

As shown in FIG. 2, a light apparatus illustrates an alternative mode of the light arrangement 10′ which comprises a light housing 11′, at least a connector 12′ coupling with the light housing 11′ for electrically connecting to a power supply source, and at least a light source 13′ received in the light housing 11′ for generating a non-neon light to penetrate through the light housing 11′.

According to the second embodiment, the light arrangement 10′ is embodied to have a fluorescent light configuration that the light housing 11′ is an elongated tubular fluorescent light casing and is made of light-transmittable or translucent material. The connector 12′ is coupled with the light housing 11′ to form a fluorescent light connector for electrically coupling with a conventional fluorescent light socket so as to electrically connect to the power supply source.

In addition, the light source 13′ comprises at least a diode unit which is electrically connected to the connector 12′ and is received in the light housing 11′ to form the light arrangement 10′ as the fluorescent light configuration. Therefore, when the diode unit of the light source 13′ is electrified, the electrode of the light source 13′ will generate the light towards the light housing 11′. Accordingly, the diode unit comprises a circuit board 131′, such as a semi-conductor chip, and at least a diode 132′ electrically coupled at the circuit board 131′, such that when the diode 132′ is electrified, the diode unit will emit the light. It is worth mentioning that two or more diodes 132′ can be electrically coupled at the circuit board 131′ to enhance the light intensity of the diode unit. As shown in FIG. 2, two or more diodes 132′ are aligned and electrically coupled at the circuit board 131′ along the elongated light housing 11′ from end to end.

As shown in FIG. 2, the highlighting element 20 is provided at the light housing 11′ and is arranged in such a manner that when the light passes through the light housing 11′, the highlighting element 20 creates a neon light emitting effect at the light arrangement 10′. In other words, when the light is transmitted out of the light housing 11′ through the highlighting element 20, a simulated neon light of a conventional neon lighting is created. Therefore, through the highlighting element 20, such as coating the highlighting element 20 at the light housing 11′ of the fluorescent light can simple generate the simulated neon light emitting effect without involving the complicated process for producing the conventional neon lightings.

A metal member 14′ is further provided at along a longitudinal reflective portion of the light housing 11′, wherein the inner side of the metal member 14′ is a light reflective surface for reflecting the light from the light source 13′ towards the longitudinal light portion of the light housing 11′. In addition, the metal member 14′ can also dissipate and transfer heat from the light source 13′.

Accordingly, the highlighting element 20 can be coated at either the inner or outer surface of the light housing 11′. Preferably, the highlighting element 20 is coated on the inner surface of the light housing 11′. Therefore, the process of coating the highlighting element 20 without alternating the structure of the light apparatus is able to simply form the light apparatus with the neon light emitting effect. Thus, the light apparatus incorporating with fluorescent light as the light source 13′ is able to emit the simulated neon light emitting effect without using the conventional neon lightings, which is complicated, expensive in manufacturing, operation, and maintenance cost, and short life thereof.

In order to configure the light arrangement 10′ as the fluorescent light configuration, the step (1) further comprises the following steps.

(1.1) Configure the light housing 11′ to form a fluorescent light housing.

(1.2) Receive the diode unit as the light source 13′ within the light housing 11′ to electrically link with the connector 12′ so as to form the fluorescent light configuration.

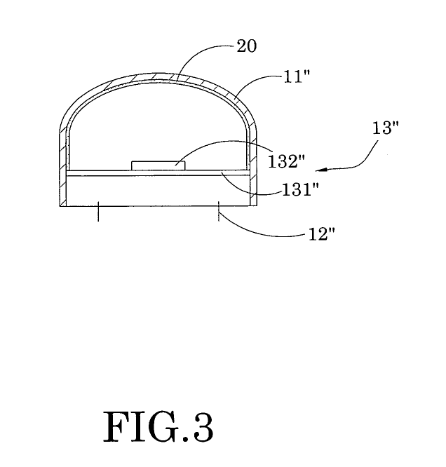

As shown in FIG. 3, a light apparatus illustrates another alternative mode of the light arrangement 10″ which comprises a light housing 11″, at least a connector 12″ coupling with the light housing 11″ for electrically connecting to a power supply source, and at least a light source 13″ received in the light housing 11″ for generating a non-neon light to penetrate through the light housing 11″.

According to the third embodiment, the light arrangement 10″ is embodied to have a LED light configuration that the light housing 11″ is lens casing and is made of light-transmittable or translucent material. The connector 12″ is coupled with the light housing 11″ to form a LED light connector for electrically coupling with a conventional LED light socket so as to electrically connect to the power supply source.

In addition, the light source 13″ comprises at least a diode unit which is electrically connected to the connector 12″ and is received in the light housing 11″ to form the light arrangement 10″ as the LED light configuration. Therefore, when the diode unit of the light source 13″ is electrified, the electrode of the light source 13″ will generate the light towards the light housing 11″. Accordingly, the diode unit comprises a circuit board 131″, such as a semi-conductor chip, and at least a diode 132″ electrically coupled at the circuit board 131″, such that when the diode 132″ is electrified, the diode unit will emit the light. It is worth mentioning that two or more diodes 132″ can be electrically coupled at the circuit board 131″ to enhance the light intensity of the diode unit.

As shown in FIG. 3, the highlighting element 20 is provided at the light housing 11″ and is arranged in such a manner that when the light passes through the light housing 11″, the highlighting element 20 creates a neon light emitting effect at the light arrangement 10″. In other words, when the light is transmitted out of the light housing 11″ through the highlighting element 20, a simulated neon light of a conventional neon lighting is created. Therefore, through the highlighting element 20, such as coating the highlighting element 20 at the light housing 11: of the LED light can simple generate the simulated neon light emitting effect without involving the complicated process for producing the conventional neon lightings.

Accordingly, the highlighting element 20 can be coated at either the inner or outer surface of the light housing 11″. Preferably, the highlighting element 20 is coated on the inner surface of the light housing 11″. Therefore, the process of coating the highlighting element 20 without alternating the structure of the light apparatus is able to simply form the light apparatus with the neon light emitting effect. Thus, the light apparatus incorporating with LED light as the light source 13″ is able to emit the simulated neon light emitting effect without using the conventional neon lightings, which is complicated, expensive in manufacturing, operation, and maintenance cost, and short life thereof.

In order to configure the light arrangement 10″ as the LED light configuration, the step (1) further comprises the following steps.

(1.1) Configure the light housing 11″ to form a lens casing.

(1.2) Receive the diode unit as the light source 13″ within the light housing 11″ to electrically link with the connector 12″ so as to form the LED light configuration.

Accordingly, the phosphor composition of the highlighting element 20 is coated on the light housing 11, 11′, 11′ to form the light bulb configuration, the fluorescent light configuration, or the LED light configuration. Because of the special composition of phosphor coating of the highlighting element 20, the light from the light source 13, 13′, 13″ allows for second light emission surface to enhance brightness. The idea is verbatim from the phosphor coating ideology for neon simulating LEDs signs.

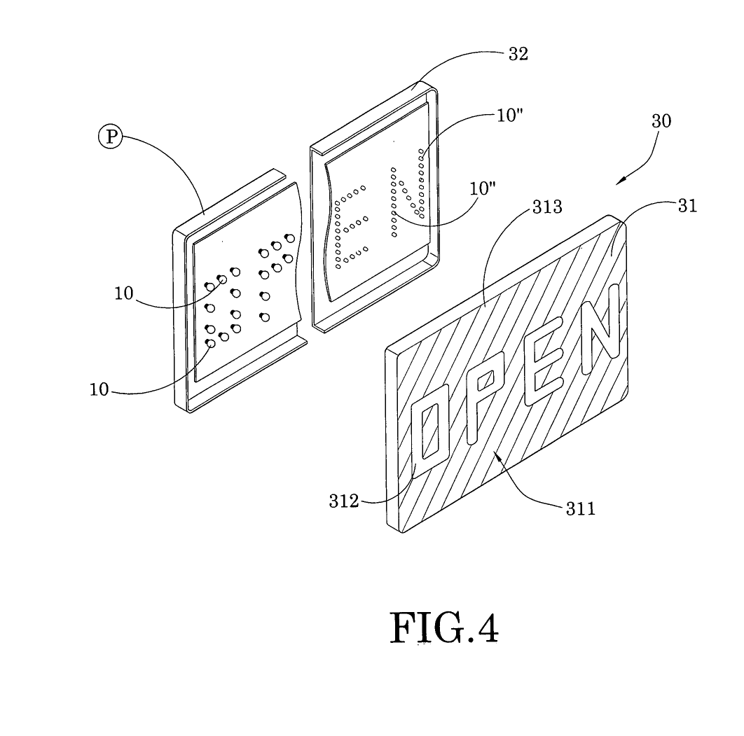

FIG. 4 illustrates an application of the light apparatus to form an illumination sign. The illumination sign comprises a sign displaying frame 30 for housing the light apparatus therein. As shown in FIG. 4, the sign displaying frame 30 comprises a sign panel 31 and a supporting base 32 coupled with the sign panel 31 to form a sign casing to receive the light apparatus therein.

The sign panel 31, which is made of light-admissible material, has a background portion 311 and a plurality of displaying portions 312 to form a corresponding number of character signs at a displaying side of the sign panel 31, wherein the displaying portion 312 of the sign panel 31 has a predetermined light admissibility for allowing light to pass therethrough. A light blocking layer 313, which is made of light-inadmissible material, overlappedly formed on the background portion 311 of the sign panel 31, wherein when light is illuminating from a rear attachment side of the sign panel 31, the light is allowed to pass through the displaying portions 312 of the sign panel 31, and simultaneously blocked by the light blocking layer 313 at the background portion 311, such that the character signs are illuminated by the light at the displaying side of the sign panel 31 through the displaying portions 312 thereof.

Accordingly, the light arrangement 10, 10′, 10″ of the light apparatus is supported by the supporting base 32 at a predetermined position. Therefore, when the light arrangement 10, 10′, 10″ generates the light towards the sign panel 31, the displaying portions 312 of the sign panel 31 will be illuminated with the neon-light effect. It is worth mentioning that the light bulb, the fluorescent light, or the LED light can be used as the light source 13, 13′, 13″ to incorporate with the sign displaying frame 30 without altering the original structure of the sign displaying frame 30. Therefore, the present invention simply generates the simulated neon light emitting effect without involving the complicated process for producing the conventional neon lightings to incorporate with the sign displaying frame 30.

FIG. 4 illustrates another application of the light apparatus to form an illumination sign. The illumination sign comprises a sign displaying frame 30 for housing the light apparatus therein. As shown in FIG. 4, the light housing 11′ is bent to form the character signs. In other words, the light housing 11′ of the light arrangement 10′ forms the sign panel to be supported by the supporting base 32. Accordingly, the supporting base 32 can be form as a framework to support the light housing 11′. It should be noted that the fluorescent light may be alternatively adapted as the light source 13′, wherein the fluorescent lighting can be bent to the substantially corresponding shape of the characters of the sign illumination with a double-sided illuminating manner.

According to the present invention, the light apparatus embodies as the light bulb or fluorescent lights, or the LED light as shown in FIGS. 1 to 3 respectively, which are simple in structure, low manufacturing cost, and flexible of being formed variety shapes thereof in order to be incorporated into different applications.

It is worth to mention that the light apparatus utilizing the light bulbs fluorescent lights and/or LED lights can also be used at home for illuminating and easily creating variety of simulated neon light emitting effect at home, office or any other places. The light bulbs with the coated highlighting elements 20 are able to be arranged to a shape or characters for being used as a commercial sign to generate the high brightness of the simulated neon light effect. The light apparatus utilizing the fluorescent lightings as the light sources 13′ can also be bent to a shape or character for spelling a word or forming a symbol to form a 3-dimensional commercial sign. The light bulbs, the fluorescent lights, or the LED lights with the coating of the highlighting element 20 can also be directly used as the commercial illumination signs.

It is worth mentioning that the light diffusion does not simply reply on the color of the light bulbs or fluorescent lightings of the light sources 13 in the supporting base, but fine tuned by the ultraviolet phosphorus coating process to achieve all spectrums of colors in current neon signs. In other words, each of the light bulbs, fluorescent lights, or LED lights may generate the light with a wave length matching an ultraviolet wave length of the ultraviolet ray phosphor coating as the highlighting element 20 at the light sources 13, 13′, 13″.

The practical purpose of the present invention is to provide an alternative to conventional neon signs in terms of performance. Yet the present invention is made of light materials and is able to utilize variety of light sources 13 for generating the simulated neon light emitting effect. As a result, light apparatus of the present invention is able to generate the simulated neon light emitting effect simply from the light bulbs, fluorescent lightings, or the like. The light bulbs or the fluorescent lightings are able to be used as both illuminating purpose and attracting purpose when used as the commercial illumination sign. The light bulbs and the fluorescent lightings are able to be arranged or bent to the corresponding character of the illumination sign or to incorporate with the sign displaying frame to form the shape of the illuminated characters thereat.

Accordingly, by incorporating the highlighting element 20 with the light source 13, 13′, 13″, all possible colors can be generated for replacing the typical neon tubing. In addition, the connector 12, 12′, 12″ of the light arrangement 10, 10′, 10″ provides ease of installation. For example, the light arrangement 10 with the light bulb configuration can fit the conventional light bulb socket. The light arrangement 10′ with the fluorescent light configuration will fit the conventional fluorescent light socket. The light arrangement 10″ with the LED light configuration will fit the conventional LED module.

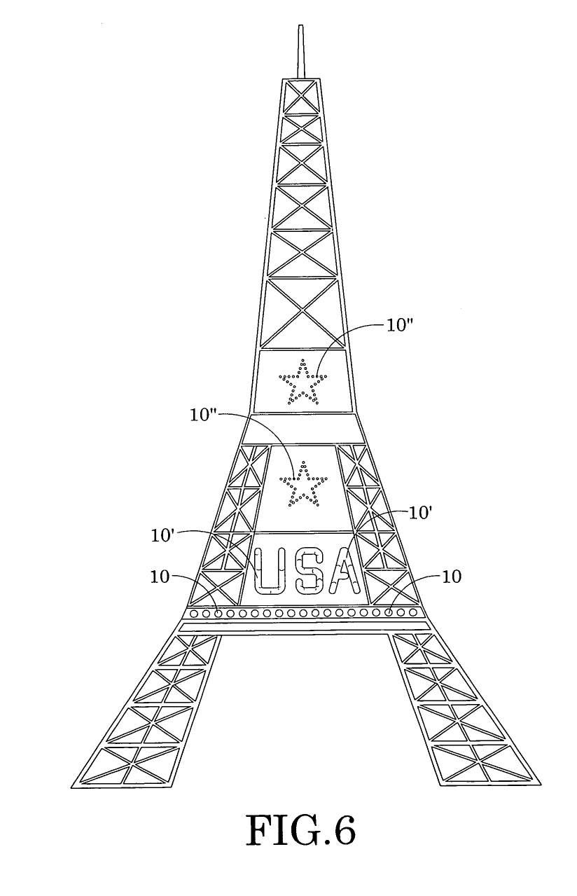

According to the present invention, an outdoor display can be built by incorporating with the light arrangement 10, 10′, 10″, wherein the light arrangement 10, 10′, 10″ are formed as a plurality of light modules to be configured to form the outdoor display as shown in FIG. 6. In particular, light bulb, fluorescent lights, and the LED light of the light arrangement 10, 10′, 10″ are combined in the outdoor display. It is worth mentioning that incorporating with different light modules of the light arrangement 10, 10′, 10″, various light effects or light motions can be provided via a control module to enhance the aesthetic appearance of the outdoor display.

It is worth mentioning that the light arrangement 10, 10′, 10″ is extremely durable that the light housing 11, 11′, 11″ can be made of high grade plastic component in compassion with the typical neon tubing which is made of fragile neon glass. In addition, the diode unit is used as the light source 13, 13′, 13″ so that it works at low voltage operation with low fire hazards. Unlike neon and other gas lamps, they use high voltage with high fire hazards. Since the light arrangement. 10, 10′, 10″ operates at low voltage condition, it can save up to 80% in energy savings versus the traditional neon/cold cathode outdoor displays.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1-22. (canceled)

23. A light apparatus, comprising:
a light arrangement which comprises a light housing, at least a connector coupling with said light housing for electrically connecting to a power supply source, and at least a light source received in said light housing for generating a non-neon light to penetrate through said light housing; and
a highlighting element provided at said light housing and arranged in such a manner that when said light passes through said light housing, said highlighting element creates a neon light emitting effect at said light arrangement, wherein said highlighting element is ultraviolet ray phosphor coating coated on said light housing, wherein said light source generates said non-neon light with a wave length matching an ultraviolet wave length of said ultraviolet ray phosphor coating coated on said light housing so as to intensify said light propagated from said light source.

24. The light apparatus, as recited in claim 23, wherein said highlighting element is coated at an inner surface of said light housing.

25. The light apparatus, as recited in claim 23, wherein said light source comprises at least a diode unit which is electrically connected to said connector and is received in said light housing to form said light arrangement as a light bulb configuration.

26. The light apparatus, as recited in claim 24, wherein said light source comprises at least a diode unit which is electrically connected to said connector and is received in said light housing to form said light arrangement as a light bulb configuration.

27. The light apparatus, as recited in claim 23, wherein said light source comprises at least a diode unit which is electrically connected to said connector and is received in said light housing to form said light arrangement as a fluorescent light configuration.

28. The light apparatus, as recited in claim 24, wherein said light source comprises at least a diode unit which is electrically connected to said connector and is received in said light housing to form said light arrangement as a fluorescent light configuration.

29. The light apparatus, as recited in claim 23, wherein said light source comprises at least a diode unit which is electrically connected to said connector and is received in said light housing as a lens casing of said diode unit to form said light arrangement as a LED light configuration.

30. The light apparatus, as recited in claim 24, wherein said light source comprises at least a diode unit which is electrically connected to said connector and is received in said light housing as a lens casing of said diode unit to form said light arrangement as a LED light configuration.

31. A method of manufacturing a light apparatus with neon light emitting effect, comprising the steps of:
(a) receiving a light source in a light housing and electrically linking said light source to a connector to form a light arrangement for generating a non-neon light to penetrate through said light housing; and
(b) providing a highlighting element at said light housing, wherein when said light passes through said light housing, said highlighting element creates a neon light emitting effect at said light arrangement, wherein said highlighting element is ultraviolet ray phosphor coating coated on said light housing, wherein said light source generate said non-neon light with a wave length matching an ultraviolet wave length of said ultraviolet ray phosphor coating coated on said light housing so as to intensify said light propagated from said light source.

32. The method as recited in claim 31 wherein, in the step (b), said highlighting element is coated at an inner surface of said light housing.

33. The method, as recited in claim 31, wherein the step (a) further comprises the steps of:
(a.1) configuring said light housing to form a light bulb housing; and
(a.2) receiving a diode unit as said light source within said light housing to electrically link with said connector so as to form a light bulb configuration.

34. The method, as recited in claim 32, wherein the step (a) further comprises the steps of:
(a.1) configuring said light housing to form a light bulb housing; and
(a.2) receiving a diode unit as said light source within said light housing to electrically link with said connector so as to form a light bulb configuration.

35. The method, as recited in claim 31, wherein the step (a) further comprises the steps of:
(a.1) configuring said light housing to form a fluorescent light housing; and
(a.2) receiving a diode unit as said light source within said light housing to electrically link with said connector so as to form a fluorescent light configuration.

36. The method, as recited in claim 32, wherein the step (a) further comprises the steps of:
(a.1) configuring said light housing to form a fluorescent light housing; and
(a.2) receiving a diode unit as said light source within said light housing to electrically link with said connector so as to form a fluorescent light configuration.

37. The method, as recited in claim 31, wherein the step (a) further comprises the steps of:
(a.1) configuring said light housing to form a lens casing; and
(a.2) receiving a diode unit as said light source within said light housing to electrically link with said connector so as to form a LED light configuration.

38. The method, as recited in claim 32, wherein the step (a) further comprises the steps of:
(a.1) configuring said light housing to form a lens casing; and
(a.2) receiving a diode unit as said light source within said light housing to electrically link with said connector so as to form a LED light configuration.
